(19) United States
(12) Patent Application Publication
(10) Pub. No.: US 2014/0222775 A1
(43) Pub. Date: Aug. 7, 2014

(54) SYSTEM FOR CURATION AND PERSONALIZATION OF THIRD PARTY VIDEO PLAYBACK

(71) Applicant: The Video Point, Yokneam (IL)

(72) Inventors: Tzahi Zohar, Yokeneam Illit (IL); Roy Ionas, Kiryat Tvon (IL)

(73) Assignee: The Video Point, Yokneam (IL)

(21) Appl. No.: 14/151,521

(22) Filed: Jan. 9, 2014

Related U.S. Application Data
(60) Provisional application No. 61/750,488, filed on Jan. 9, 2013.

(51) Int. Cl. G06F 17/30

(52) U.S. Cl. CPC G06F 17/30864; G06F 17/30858
USPC 707/709

(57) ABSTRACT

A system and method for providing an improved video experience are disclosed. The system can comprise one or more algorithms for choosing and providing videos, or other media, to users based on a number of inputs. The system can provide a list of videos from which undesirable (e.g., offensive or low-quality) videos have been removed. The system can also create custom channels based on user preferences. The system can also update user preferences in real-time based on user feedback during use.

### CROSS REFERENCE TO RELATED APPLICATIONS

This Application claims priority to and benefit under 35 USC §119(e) of U.S. Provisional Patent Application Ser. No. 61/750,488, entitled “SYSTEM FOR CURATION AND PERSONALIZATION OF THIRD PARTY VIDEO PLAYBACK,” filed Jan. 9, 2013, which is hereby incorporated by reference as if fully set forth below.

### BACKGROUND OF THE INVENTION

1. Field of the Invention

The present invention relates generally to a method for providing an improved video experience, and specifically to an algorithm for choosing and providing videos to users based on a number of data points.

2. Background of Related Art

Video curation is the process of sorting through the vast amounts of videos on the web and presenting it in a meaningful, coherent, and organized way around a specific theme. This can comprise, for example and not limitation, aggregating, qualifying, sifting, sorting, classifying, and arranging videos into the right playlist/category/display time. This can also include arranging videos based on user preferences. Video curation can provide end-users with the best, most relevant video content for them. Video curation is generally done today either by professional curators, who continually watch videos and manually apply the above process, or by crowd sourcing where videos are rated by a large group of users.

Video curation is an important component for fixing gaps in third party content. Using curation with the existing crowd source or manual methods, however, can result in problems with scalability, accuracy, synchronization, and learning. Manually reviewing videos, for example, is difficult to scale, can be expensive, and generally can't be done continuously or in real time. The Crowd source method, on the other hand, can have high failure rates and timeliness issues because crowd sourcing does not inherently accumulate knowledge. Also, using these techniques may not address all the issues mentioned above (e.g., disparate video web sources, quality, etc.).

Providing third party videos using new media is desirable for many video service providers, mobile operators' websites, and other front end service providers that want to present the up-to-date, popular, and relevant video content. You Tube, for example, provides a variety of web based videos including personal videos, advertisements, and professional movie trailers, among other things. Service providers, such as You Tube, face a number of challenges when using such content, however, including, but not limited to, finding relevant content, handling multiple media formats, and tagging and labeling issues. There are thousands of web sources for videos, for example, but the average person or content manager may only be familiar with a limited number of sources. As a result, relevant, valuable content may not be found and provided. In addition, digital video is presented in a number of different formats (e.g., .avi, .mpeg, .wmv), so of which require proprietary software to play.

This means there is no single standard of how for publishing videos on the internet. In addition, there is no single standard for monetizing videos among websites. You Tube, for example, provides compensation, in part, based on the number of “hits” a video receives (i.e., how many times it is watched). There is also no single standard for metadata structures. In other words, not all sites provide the duration, category, or other information for a video embedded in the video. In addition, monetizing third party content may result in a violation of its terms of use, or other legal issues.

There are also multiple streaming technologies (e.g., HTTP and RTMP) that may require multiple streaming platforms. Because there is little incentive to properly tag videos, and may, in some cases, be an incentive to mistag videos, there are many cases where users upload content and label it improperly. In other words, videos are tagged with irrelevant or misleading tags (e.g. uploading a violent video while tagging it as a cartoon). Presenting such videos on a commercial service can be quite harmful to the user, and this to the service provider, any can result in law suits and other legal action.

There is also a problem with disparate video quality on the web. Since much of new media contains user generated content, semiprofessional content, professional content, and mixtures thereof, there is naturally a mix of video quality. This quality of a video provided at 480i compared to one provided at 1080p, for example, is significant. In addition, third party videos may not be available at all times due to temporal or geo based issues, for example. If, for example, a video is located on a server that is down for maintenance, that video should preferably be marked as temporarily unavailable. Unavailability of content can be a major obstacle for a service provider trying to deliver high end service.

Much of the content available on the web can be illegal. User generated content web sites, for example, often contain content that was copied and published illegally (e.g., a popular TV series or movie that was recorded and uploaded to sharing web site), but was not discovered by the web sites filters. In addition, at present, there is no central video qualification relevancy authority. This means that videos may not be well sorted and classified (e.g., into categories of interest) or that the videos cannot be matched to a particular end-user's interests and preferences. Similarly, web videos usually have no connection between them, making watching each video a somewhat autonomous event. End users, on the other hand, may prefer to watch multiple videos on the same subject, for example.

What is needed, therefore, is a system that can locate and classify videos with a high degree of accuracy. The system should use information provided in a user's profile, updated periodically, to provide videos relevant to a user's current interests. The system should enable offensive, illegal, low-quality, or otherwise undesirable content to be removed either automatically or manually. It is to such a system that embodiments of the present invention are primarily directed.

### BRIEF SUMMARY OF THE INVENTION

Embodiments of the present invention relate to a system, The Video Point (or, “TVP”), an automated video curation platform, which can aggregate, qualify, sift, sort, classify, and arrange web videos in a highly personalized manner based on the end-user's profile and preferences. The platform is a turn-key solution designed for use by TV service providers, for example, and can be provided either as a Software-as-a-Service (“SaaS”) or as packaged software. The solution can support multiple languages and multiple end-user devices, among other things.

TVP is a system that can collect and auto curate videos based on configuration information from third party videos, which can include videos from content partners and/or videos from the internet. The system can also curate private videos (e.g., videos owned and managed by the customer).

The system can be compared to a smart factory that collects videos from a large, ever-increasing set of video sources that processes the videos into more useful content (i.e., the curation process), removes low quality, abusive, and/or inappropriate content, and re-arranges the remainder in a manner that enables sophisticated usage thereof. The main system components can comprise, for example and not limitation, video collection, analysis, filtration, dynamic categorization, and/or user profile incorporation.

TVP video curation results can be exported and used by different platforms including, but not limited to, an application programming interface (API), off the shelf widgets and applications (apps), white label user interfaces (UIs), and web portals. For use with APIs, TVP can provide details for searching and receiving video recommendations or any other form of video presentation (e.g. channels) in a manner that considers API requests and matching results based on curation classifications. If TVP receives an API request for travel videos related to Paris, for example, the result will be videos the curation process has identified as high quality video content related to travel in Paris. TVP can also receive a recommendation request based on a particular video and then match that video to curation identifiers (e.g., category, quality, etc.) and recommend related videos based on same. When used with off the shelf video widgets/applications, the automatic video widgets can be placed within a web site and can receive inputs for TVP. As with APIs, TVP can provide outputs (recommended videos) based on these inputs (i.e., user requests and preferences).

The system can also be implemented as a white label UI packages that can be customized by any service provider. This can enable a service provider to provide branded, customized interfaces based on, for example, user skill level, content type, and user connection type (i.e., cable, DSL, or satellite), among other things. These UI packages can also be tailored for specific platforms such as, for example and not limitation, smart phones, tablets, laptops, desktops, and TVs. The system can also be implemented as a web portal that can directly access the curation results by searching videos based on the results of curation.

These and other objects, features and advantages of the present invention will become more apparent upon reading the following specification in conjunction with the accompanying drawing figures.

### BRIEF DESCRIPTION OF THE DRAWINGS

FIG. 1 is a graphical depiction of The Video Point (TVP) system, in accordance with some embodiments of the present invention.

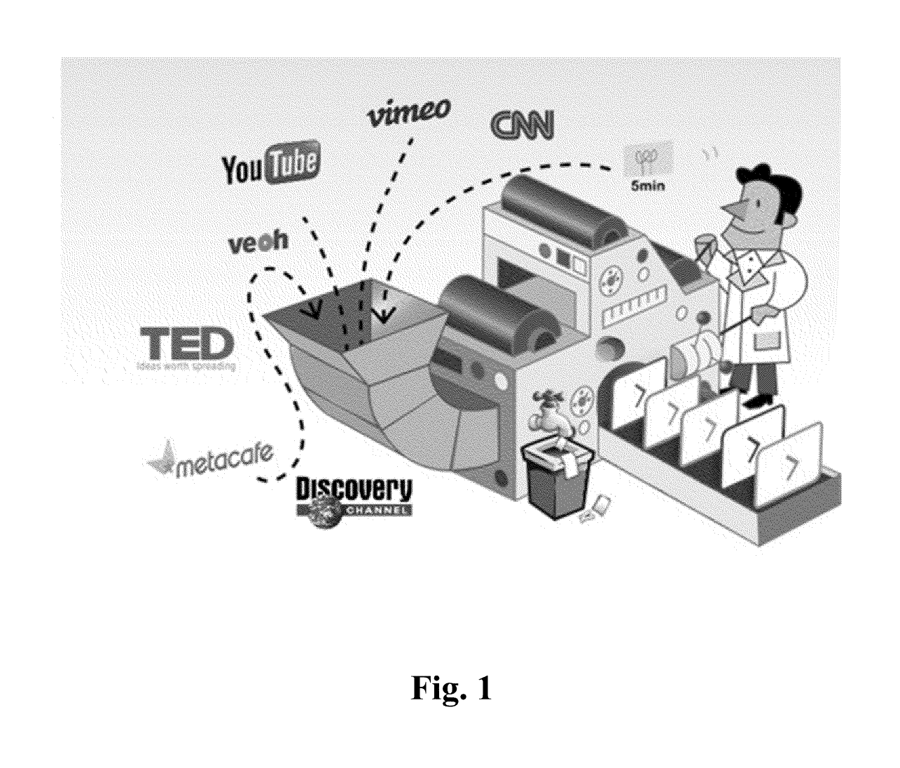

FIG. 2 is a flowchart diagramming the various components that comprise the Video Point Data Center, in accordance with some embodiments of the present invention.

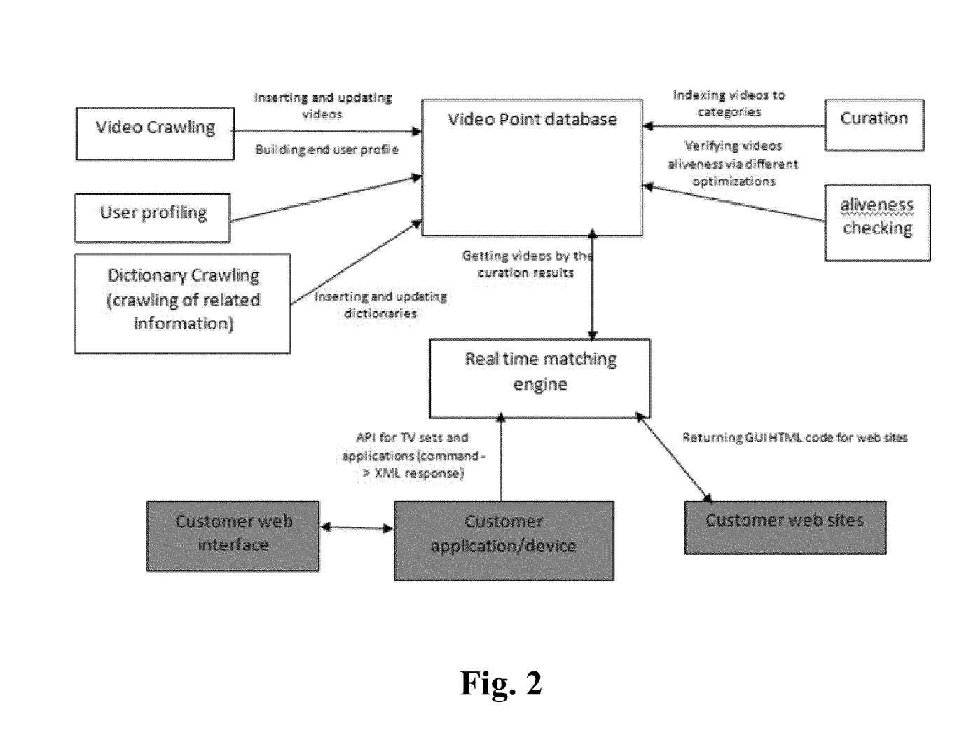

FIG. 3 is a flowchart depicting a curation engine for TVP system, in accordance with some embodiments of the present invention.

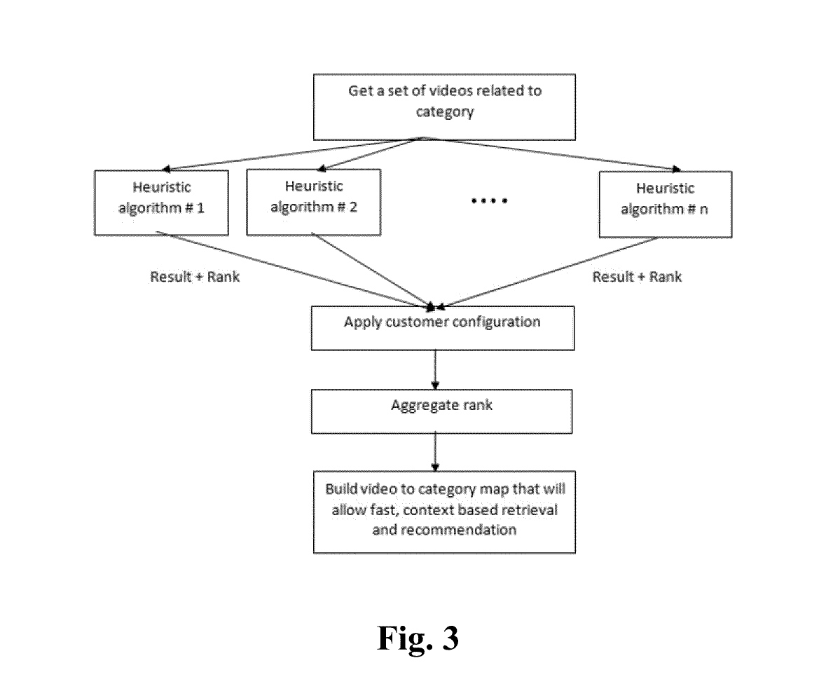

FIG. 4 is a depiction of an exemplary user interface (UI) depicting a Create Smart Channel dialogue for TVP application programming interface (API), in accordance with some embodiments of the present invention.

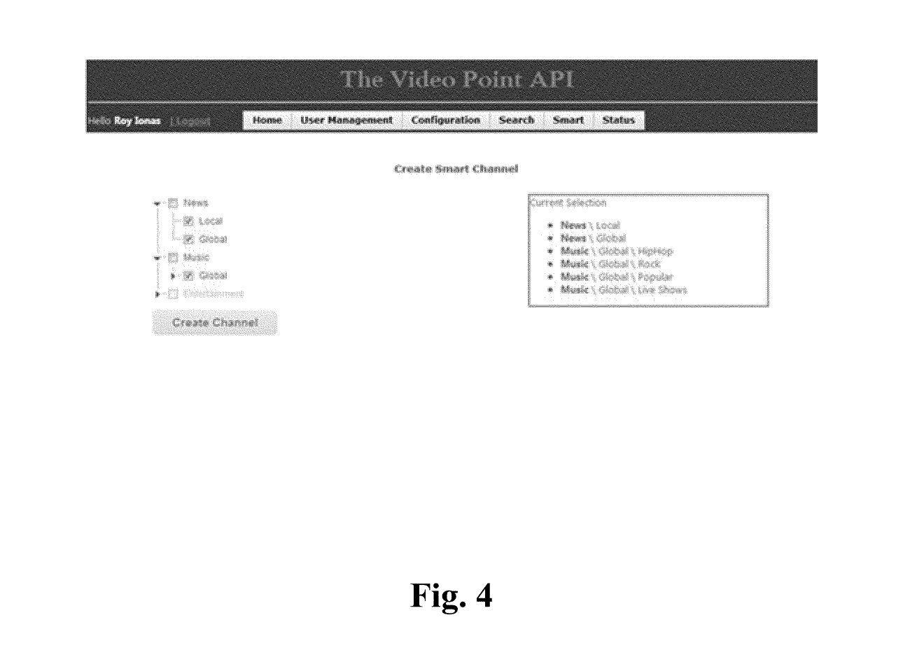

FIG. 5 is a flowchart depicting the system updating user preferences based on user actions, in accordance with some embodiments of the present invention.

### DETAILED DESCRIPTION OF THE INVENTION

Embodiments of the present invention are related generally to a method for providing an improved video experience, and specifically to an algorithm for choosing and providing videos to users based on a number of data points. The system can provide a list of videos from which undesirable (e.g., offensive or low-quality) videos have been removed. The system can also create custom channels based on user preferences.

To simplify and clarify explanation, the system is described below as a system for curating and managing videos. One skilled in the art will recognize, however, that the invention is not so limited. The system can also be deployed for other applications such as, for example, song curation, restaurant recommendations, or anywhere data collection, curation, and tracking are desirable.

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention, for example. Any dimensions listed in the various drawings are for illustrative purposes only and are not intended to be limiting. Other dimensions and proportions are contemplated and intended to be included within the scope of the invention.

As discussed above, service providers face a number of challenges when using web video including, but not limited to, finding relevant content, handling multiple media formats, and tagging and labeling issues. Videos are often, intentionally or not, mislabeled and/or miscategorized. Videos are available in a wide variety of formats and qualities. It can also be difficult to monetize web video content for a number of reasons.

To address these concerns, embodiments of the present invention are related to a system and method for providing an improved user experience using algorithms that provide relevant, high-quality video that has been “vetted” in a number of ways. In some embodiments, therefore, The Video Point (TVP) system can comprise a Video Point Data Center (VPDC). The VPDC can comprise a number of components, including but not limited to, one or more web crawlers, and one or more curation engines.

Crawlers

The VPDC can comprise multiple types of crawlers including, but not limited to, video web crawlers and text crawlers. As the name implies, video web crawlers “crawl” the web looking for information on videos. These web crawlers can run 24/7 and can scan the growing list of videos sites. The web crawlers can be generic and can handle many types of websites, in many languages and formats. Adding new websites to be crawled can be done automatically or can utilize a one-time manual operation for matching the site's parameters to a large metadata range. The web crawlers can be constantly fetching videos and entering them to TVP database.

Text crawlers, on the other hand, can crawl additional information on the internet to fetch additional metadata related to the videos and general metadata that will assist in the curation process. This metadata can include, for example and not limitation, crawling news items and isolating the repeating terms (e.g., finding the most popular new topics) either locally or generally, crawling music bill boards for top music hits, crawling forums searching for videos forwarded there in related to topics, and crawling video indexing sites (i.e., sites that manually present embedded videos based on a topic) that were edited manually by the web site content editor). Of course, other types of crawlers could be used and are contemplated herein. As discussed below, the crawlers can be used to feed information into the curation engine for further analysis.

Curation Engine

Embodiments of the present invention can also comprise a curation engine. In some embodiments, the curation engine can comprise a process that runs constantly. The engine can be used to map quality content to topics/category desired by TVP's customer base. This can be based on, for example and not limitation, customer configuration and usage patterns. The curation can include all the videos in TVP's database and can, for example, build a rank table based on the video matching by TVP's ranking algorithms. The ranking algorithms can be, for example, a set of heuristics algorithms that provide a confidence rating of the video matching the desired category.

Each combination of customer and category can result in different heuristic algorithms, or different weight division between the algorithms, based on the category and/or a particular customer pattern. For a news category, for example, the date may be given greater weight to provide more relevant results, while for travel the date may be quite minor. The curation process can run one or more of the algorithms and collect all the accumulated rankings from each, including, but not limited to, screening out videos that did not pass a predetermined ranking threshold and prioritizing video content related to a category based on the accumulated ranking of the curation.

In some embodiments, in each different category, the curation process can utilize the various algorithms differently and may, for example, provide each with a different weight in terms of the scoring percentages. For news content, for example, the date (i.e., the date the video was uploaded) may be given more importance because users may not be looking for old news stories. The result of the curation process can be a video index, including categories, that also enables retrieval of the best videos based on context.

Video Curation Component Dependency

In some embodiments, the curation engine and heuristics can be impacted by data provided in the user profile. In addition, the engine can also be influence by the video database and the video collection mechanism. Heuristics ranking in categories can also be determined by, for example and not limitation, users behavioral feedback (i.e., learning the user's preferences), external editorial sources such as, for example, bloggers, Facebook, or Twitter feeds, and complex rules including, but not limited to, geographic tagging, demographics, psychographics, and user knowledge.

In some embodiments, the curation engine can comprise an end user process. In some embodiments, the end user profile is a process that can be run constantly at the VPDC and used to build a dedicated user profile for each related category and context. The profile can indicate, for example, which type of videos are preferred by the user and can contain a selected set of metadata related to the relevant category. The profile can be based on the user activity with TVP system and can also be based other user information.

For news, the related metadata, for example, can include websites the user frequently uses for video (e.g., CNN), areas or topics the user searches or watches frequently (e.g., the Middle east or Obama), specific interviewers, producers, etc., and typical length of videos. Music related metadata, on the other hand, may include artists/albums, music genres, live shows, and new music vs. classic music, among other things.

Video Aliveness

In some embodiments, the curation engine can comprise a video aliveness process. The video aliveness mechanism is a checking mechanism that can run constantly and can verify, among other things, that the video still exist and is still available on the web. The detection can be based on an efficient set of heuristics algorithms, for example, that are based on the nature of the web source involved. In some embodiments, for longer videos (e.g., videos 5 min. or longer), for example, there can be a dedicated, robust, fast API call that checks to ensure that each video is alive. Many sites remove the thumbnail related to the video when they remove the video, which can also be used to check availability. Checking the thumbnail can provide a simple, accurate, robust, and scalable method for verifying videos. In addition, the system can simply check to see if the actual video file exists.

In some embodiments, once a video is identified as dead, the system can provide a notification to the user. In this manner, the user can delete the video form his profile or, if he knows the video will likely be available in the future, he can leave it on his profile. In other embodiments, identification of a dead video can result in immediate, automatic removal of the video by the system without additional operator input.

Real Time Matching Engine

In some embodiments, the curation engine can comprise real time matching engine. In some embodiments, the real time matching engine can utilize the full input of the request—e.g., user id, type of request (search/recommendation/widget/etc), and additional parameters—and the curation output and combine them in a manner that will create an improved user experience. Based on the curation process, for example, the real time engine can provide improved functionality, including, but not limited to, recommendation of videos to user, recommendation of videos based on text or additional videos, and automatic channel selection.

User Interface

Because the system is customizable for specific providers, it can include an advanced user interface that the provider can set for prioritizing content, promoting his own interests, etc. The advanced configuration can comprise, for example and not limitation, sites and channels the providers wish to promote, type of content the provider wishes to block such as, for example and not limitation, sites, channels, competitor videos, parental control, etc. In other embodiments, the system can include detailed user and general statistics in multiple formats such as, for example, email reports, Excel® spreadsheets, and statistical query systems. The system can also provide the ability to retrieve analyzed user profiles to be used in other systems such customer relationship management (CRM).

The system can also provide a number of additional innovative features. In some embodiments, the system can provide a list of relevant video sites. The list of video sites provided by the web crawlers in the VPDC can contains multiple types of web sources including, but not limited to, web sites found by TVP administrator, web sites requested by TVP's customers, and web sites discovered automatically by scanning the internet for new video sites. In some embodiments, the system can auto scan multiple sites that match the pattern of video types. The system can also scan for the forwarding of videos at forums and social networks that use common links, posts related to videos in chat rooms or other sources, and the number of views a video has received on other sites or on the web in general (so called, “viral videos”). This can lead to a pattern of videos detectable by TVP crawlers. In this manner, the system provides a maximum number of solutions for the consumer and continuously adds sources in excess of what could be added using the manual location and addition of sites.

In some embodiments, to provide an effective curation process, it may be desirable to retrieve a fairly extensive set of data for each video. As mentioned above, generally speaking, each site maintains a particular set of accessible metadata on the videos provided on the site. In some embodiments, therefore, the system can employ an automatic or manual correlation between the available metadata and the complete set of video metadata used by the system in order to maximize searchability. Once a web site is located by TVP, if there is a failure in retrieving some or all of the relevant metadata (which can be due to a mismatch in web site design or syntax, for example) a notice, or “trap,” can be sent to TVP administrator for manually updating the correlation process.

Confidence Assuring Algorithms

In some embodiments, the system can utilize confidence assuring algorithms, or curation heuristics. In some embodiments, for example, the system can search keywords. In other words, for many categories, it is possible to use text matching of the video metadata to dynamic or static set of keywords (i.e., a dictionary) that describes a given category or user. In addition, the internet contains many video indexing sites that are populated with, for example, topics and related video links. As a result, the appearance of a video on such sites can provide some assurance that the video is related to the category mentioned on the indexing site. In some embodiments, the system can scan top sites that embed videos Like indexing sites, major websites embedding a video from a user generated video website, for example, tends to provide higher confidence in the video. In other words, because these videos are generally manually selected by a content editor (or similar) and from the metadata contained therein, the metadata in the embedding site tends to be more accurate.

In some embodiments, the system can also scan forums. In many forums (e.g., the “Trip Advisor” travel forum), for example, users paste links to videos related to their comment. In a hotel review, for example, a user can place a link to a video (e.g., a YouTube video) next to the post related to that destination. This also tends to provide reliable input related to the video quality and relevance. The system can also take into account the source for the video. If a video originates from a proven, high quality video source or a video channel (e.g., CNN) then it is likely of good quality and relevance.

In some embodiments, the system can also take a sort of multi-pronged “crowd sourcing” approach. The system can, for example, scan Facebook profiles. If many people place videos or links to videos on their wall with comments, this can provide relevant videos, particularly with respect to popularity. Similarly, scanning internet based playlists can also point to videos with increased popularity. In addition, the system can compile all the feedback from the end users (e.g., viewing, likes, sharing, reposting, etc.) to determine popularity.

User Profiles

The system can be personalized using a number of factors. In some embodiments, the personalization provided by TVP can be based on multiple simultaneous factors such as, for example and not limitation, user, category/topic, and context. The addition of context provides the customer with the ability to define contexts from which a user profile can be generated. This can include, for example, news in the morning vs. news in the evening, i.e., a user may desire a different type of news in the morning than in the evening due to, among other things, the time of the day and/or the user's attention span. This can also include special events in sports, such as the Olympics or the World Cup.

Building a user profile, even an accurate one, does not necessary meet real time needs. As a result, TVP real time engine can contain additional real time preferences from the user profile based on current user preferences. If the user is a fan of multiple sport areas (e.g., soccer, basketball, and tennis), for example, but the user is currently only watching tennis (e.g., because Wimbledon is on), then the real time profiling can focus in for the given session, or a given time period, for example, and give priority to that specific content area. In addition, the system can also incorporate external sources related to the user (e.g., their Facebook ID, LinkedIn ID, etc.) to enable the system to constantly crawl those sources for additional, relevant, timely information to enable a further improved user profile.

In some embodiments, the system can also utilize channels based on user preferences. In some embodiments, the system can provide full channels with series/episodes hierarchy, but web-based, similar to conventional TV channels. The channels can be based on TVP's engine, which provides deep metadata of automatically selected videos. Using this information, the system can generate channels with well-structured series/episodes. IN some embodiments, the channels can be compiled as a combination of short clips, which can create a better experience and increased engagement for the end user. Shorter formats can also alleviate problems associated with bandwidth and connection issues caused by various user internet connections. In some embodiments, the system can also accommodate special channels. These can be channels created by a content editor and can include niche interests or hot topics, for example.

TVP can also provide, among other features, the ability to create automatic user based channels. In other words, a channel can be configured on which the user can play multiple videos consecutively without interruption, similar to a conventional TV channel. The multitudes of internet videos allow an enormous set of videos to be assembled to create a channel on almost any topic. The user could create an “NBC Thursday Night in the 90's” channel, for example, Additionally, TVP's personalization and real time profiling can enable user based video to be provided on specific topics based on the user's profile that is constantly updated and customized based on real time activity and profiling. If the system auto creates an extreme sports channel for a user because he often watches surfing, skiing, and bungee jumping, for example, but in real time he often skips surfing, surfing can eventually be removed from his extreme sports channel.

The smart channel is an advanced feature that can create a personal, user based video channel-type experience based on any set of categories and topics. In this manner, the user can create a channel based in relation to multiple categories/topics in real time by accessing an API. This will result in a video feed that suits the combination of requests the user is making in real time to provide a customized channel, like a TV channel, but customized to the user's preferences.

The fact that the channel is still internet based, however, provides a viewer-on-demand (VOD) experience, which enables the operator to replay or skip videos, provide “like”/“dislike” feedback, and passive feedback (i.e., viewing all or part of the video), among other things. This type of feedback can provide additional information about which subset of the channel the user wants to see in real time and automatically refresh the online channel.

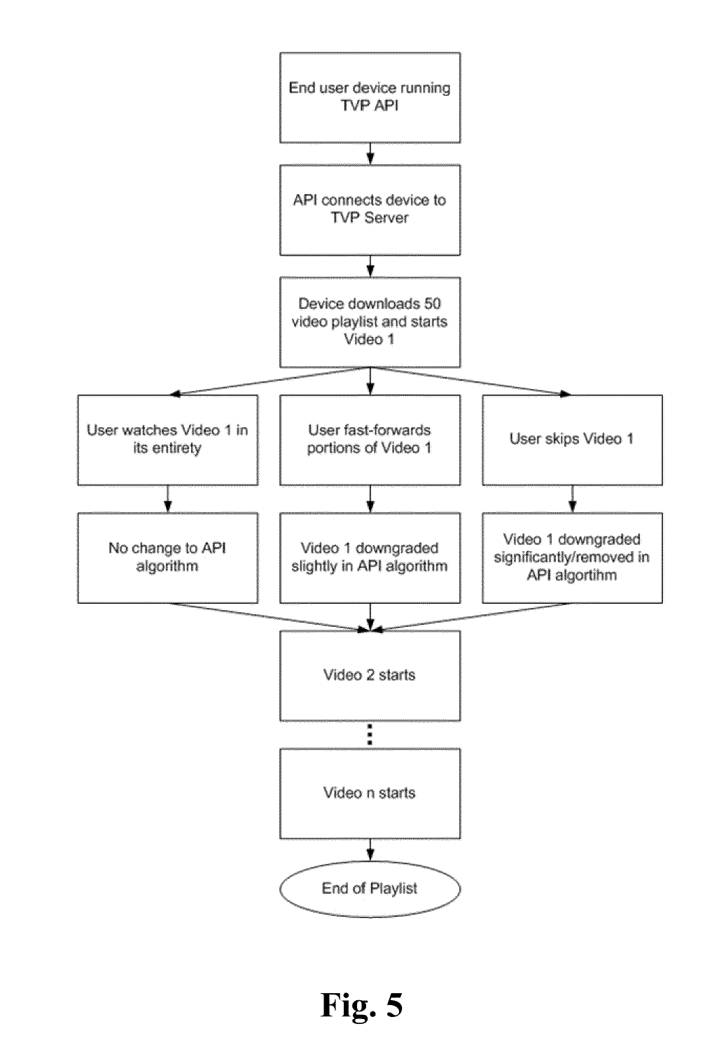

As shown in the FIG. 5, the system can update user preferences based on user actions. After logging on to the TVP server, for example, the user's device can download a playlist of recommended videos. If the user then watches all of video 1, the system assumes a correct choice and makes no modifications to the video choosing algorithm. If, on the other hand, the user fast forwards through some or all of the video, the system may downgrade that video based on the amount of the video the user skipped. If the user skips a video entirely, or almost entirely, the system can remove that video from the playlist and update the algorithm accordingly.

While several possible embodiments are disclosed above, embodiments of the present invention are not so limited. For instance, while several possible configurations for TVP have been disclosed, other suitable configurations, components, and combinations of components could be selected without departing from the spirit of embodiments of the invention. In addition, the location and configuration used for various features of embodiments of the present invention can be varied according to a particular computer system, internet connection, or platform that requires a slight variation due to, for example, the bandwidth or connection constraints. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A method of curating video comprising:
creating a user profile containing a first set of data points related to a user;
crawling one or more web-based video sources to locate a plurality of videos containing a second set of data points;
indexing the plurality of videos into a plurality of categories;
comparing the first set of data points to the second set of data points to locate a first set of videos relevant to the user; and
providing a list of the first set of videos relevant to the user.

2. The method of claim 1, wherein crawling one or more web-based video sources comprises one or more of video crawling and text crawling.

3. The method of claim 1, wherein the second set of data points comprises metadata from the plurality of videos.

4. The method of claim 1, wherein the first set of data points comprises videos the user has watched within a first predetermined time period.

5. The method of claim 4, further comprising:
wherein more recently watched videos are weighted more heavily in the comparison.

6. The system of claim 1, wherein the plurality of categories comprise one or more of video subject, video length, video quality, and keywords.
